(19) United States
(12) Patent Application Publication
(10) Pub. No.: US 2026/0197209 A1
(43) Pub. Date: Jul. 9, 2026

(54) METHOD FOR EQUALIZING AN INPUT SIGNAL AND EQUALIZATION APPARATUS FOR EQUALIZING AN INPUT SIGNAL

(71) Applicant: Rohde & Schwarz GmbH & Co. KG, Muenchen (DE)

(72) Inventors: Thomas KUHWALD, Muenchen (DE); Martin PESCHKE, Muenchen (DE); Wolfgang HERBORDT, Muenchen (DE); Philip DIEGMANN, Muenchen (DE); Michael GRIMM, Muenchen (DE); Christian SCHMIDT, Muenchen (DE)

(21) Appl. No.: 19/008,868

(22) Filed: Jan. 3, 2025

(51) Int. Cl. H04L 25/03

(52) U.S. Cl. CPC H04L 25/03038; H04L 25/03261

(57) ABSTRACT

A method for equalizing an input signal is described. The method includes the steps of receiving an input signal; sampling the input signal with a pre-defined sampling rate, thereby obtaining a sampled signal; applying a decimating filter to the sampled signal, which results in a decimated signal having a reduced sampling rate; and applying a digital filter to the decimated signal, thereby obtaining a filtered signal having an at least partially corrected frequency response. Further, an equalization apparatus for equalizing an input signal is described. The equalization apparatus comprises an input for receiving an input signal and an electronic circuit configured for sampling the input signal with a pre-defined sampling rate, applying a decimating filter to the sampled signal, and applying a digital filter to the decimated signal, thereby obtaining a filtered signal having an at least partially corrected frequency response.

### FIELD OF THE DISCLOSURE

Embodiments of the present disclosure generally relate to a method for equalizing an input signal. Embodiments of the present disclosure also relate to an equalization apparatus for equalizing an input signal.

### BACKGROUND

Measurement setups for measuring a signal can have an undesired frequency response, e.g. a frequency response that is not essentially flat. There are techniques for correcting the frequency response after the signal was sampled via an analog-to-digital converter (ADC). The process of frequency-response correction is also known as de-embedding. Such de-embedding techniques are typically applied to measurements on fast signal transmission systems like e.g. universal serial bus (USB), Ethernet, or PCI Express (PCIe).

However, conventional de-embedding techniques are computationally inefficient when applied to systems that operate at low frequencies, for example measuring devices like current clamps or power sensors. Therefore, frequency response correction is often spared completely in these cases.

Accordingly, there is a need for performing an efficient frequency response correction on low-frequency signals.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

The present disclosure provides a method for equalizing an input signal. The method comprises the following steps:
receiving an input signal;
sampling the input signal with a pre-defined sampling rate, thereby obtaining a sampled signal;
applying a decimating filter to the sampled signal, which results in a decimated signal having a reduced sampling rate; and
applying a digital filter to the decimated signal, thereby obtaining a filtered signal having an at least partially corrected frequency response.

Accordingly, the method allows performing an efficient frequency response correction on low-frequency input signals that were sampled at a relatively high sampling rate. Conventionally, correcting a frequency response on such signals is associated with a prohibitively high computational effort. Due to this constraint, a frequency response correction is often dispensed with completely in such constellations.

However, since the method according to the present disclosure performs the frequency response correction on a decimated signal having a reduced sampling rate, the computational effort is reduced substantially. The benefits of frequency response correction are thus made available to a wide range of applications involving low-frequency input signals.

Generally, the filtered signal may be acquired and processed further, for example directly after the frequency response has been corrected. The further processing steps can thus be performed on a signal that has an at least partially corrected frequency response.

According to one aspect, the decimating filter may be a cascaded integrator-comb (CIC) filter. Specifically, a CIC filter is an instance of a decimating as well as band limiting filter. In addition to the sampling rate reduction, the signal can thus be limited to a specific frequency range.

According to another aspect, the decimating filter may comprises a cascade of at least two low-pass filters. A low-pass filter especially attenuates signal components having a frequency higher than a selected cutoff frequency and passes the remainder (i.e. the lower-frequency components) of a signal.

The cascade may comprise for example at least one finite impulse response (FIR) filter and a cascaded integrator-comb filter. A finite impulse response filter is especially a filter whose response to a finite length input (e.g. an impulse) is of finite duration.

The decimating filter may be an alias free filter. More specifically, the decimating filter does not introduce aliasing errors (i.e. distortions or artifacts) to the sampled signal. In case aliasing effects occur, they may be suppressed.

An interpolator may be applied to the filtered signal for up-sampling so as to return to essentially the pre-defined sampling rate. Hence, the filtered signal with corrected frequency response can be made available in the original pre-defined sampling rate for further processing.

The interpolator may be a finite impulse response filter. The up-sampling can thus be performed in a stable manner and without requiring feedback.

The interpolator can be for example a cascaded integrator-comb filter. Hence, the interpolator can be implemented in a computationally efficient manner in digital hardware.

By applying the interpolator, an up-sampled signal can be obtained, which may be acquired and processed further. Additional signal processing (including analysis) can thus be performed on the up-sampled signal, which has essentially the original pre-defined sampling rate.

The digital filter used for correcting the frequency response may correct a magnitude and a phase of the input signal at least partially. Hence, an undesired frequency response can be corrected with respect to a frequency-dependent magnitude as well as a frequency-dependent phase.

The input signal may be a measurement signal from a measuring device. Accordingly, a frequency response of the measuring device can be corrected by applying the digital filter to the decimated signal. The measuring device can be for example a probe or a clamp. The measuring device may especially be a power probe, a power sensor, or a current clamp.

The present disclosure further provides a non-transitory computer-readable medium storing instructions that, when executed by an electronic circuit, cause the electronic circuit to perform a method for equalizing an input signal as described herein.

In addition, the present disclosure provides an equalization apparatus for equalizing an input signal. The equalization apparatus comprises an input for receiving an input signal and an electronic circuit configured to perform a method comprising the following steps:
sampling the input signal with a pre-defined sampling rate, thereby obtaining a sampled signal;
applying a decimating filter to the sampled signal, which results in a decimated signal having a reduced sampling rate; and
applying a digital filter to the decimated signal, thereby obtaining a filtered signal having an at least partially corrected frequency response.

Features and advantages described above regarding the method for equalizing an input signal also apply to the equalization apparatus.

In embodiments, the equalization apparatus may comprise at least two inputs and the electronic circuit may be configured to perform the method on at least two channels. Accordingly, frequency response correction can be performed on multiple signals simultaneously. For example, the frequency response of multiple measuring devices or of a multi-channel measuring device can thus be corrected.

Optionally, the electronic circuit may be configured to apply the decimating filter to the sampled signal after writing the sampled signal to an acquisition memory of the equalization apparatus and before performing further signal processing. In this case, acquisition of the input signal can thus be performed in a conventional manner before reducing the sampling rate of the input signal.

In addition, the electronic circuit may be configured to apply the digital filter to the decimated signal for correcting the frequency response before performing further signal processing. Hence, the further signal processing can be performed on the filtered signal having the at least partially corrected frequency response.

Furthermore, the electronic circuit may be configured to apply an interpolator to the filtered signal for up-sampling so as to return to essentially the pre-defined sampling rate after correcting the frequency response and before performing further signal processing. Accordingly, the further signal processing can be performed on a filtered signal that has essentially the original pre-defined sampling rate. It is thus possible to perform also signal processing steps that require the sampling rate to have the original pre-defined value.

The equalization apparatus may be for example an oscilloscope. Hence, processing and analysis functions of the oscilloscope can be applied to the filtered signal having the at least partially corrected frequency response.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a block diagram schematically illustrating a method for equalizing an input signal according to the prior art;

FIG. 2 is a block diagram schematically illustrating a method for equalizing an input signal according to an aspect of the present disclosure;

FIG. 3 is a block diagram schematically illustrating a method for equalizing an input signal according to another aspect of the present disclosure;

FIG. 4 is a block diagram schematically illustrating a method for equalizing an input signal according to yet another aspect of the present disclosure; and

FIG. 5 schematically shows an equalization apparatus according to the present disclosure, which is connected to a measuring device.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

For the purposes of the present disclosure, the phrase “at least one of A, B, or C”, for example, means (A), (B), (C), (A and B), (A and C), (B and C), or (A, B, and C), including all further possible permutations when more than three elements are listed. In other words, the term “at least one of A or B” generally means “A and/or B”, namely “A” alone, “B” alone or “A and B”.

In general, de-embedding is the correction of undesired properties of the frequency response of a system to arrive at a desired frequency response. For signals comprising high frequencies, typical causes of an undesired frequency response are impedance mismatch, fundamental cable properties, and resonances in electronic circuits.

Since it is impossible to mitigate these properties fully in the analog domain, they are addressed via digital signal processing. A prerequisite is that the actual frequency response is known. For this, a user can perform a one-time determination of the typical frequency response or the frequency response can be determined as part of a factory calibration.

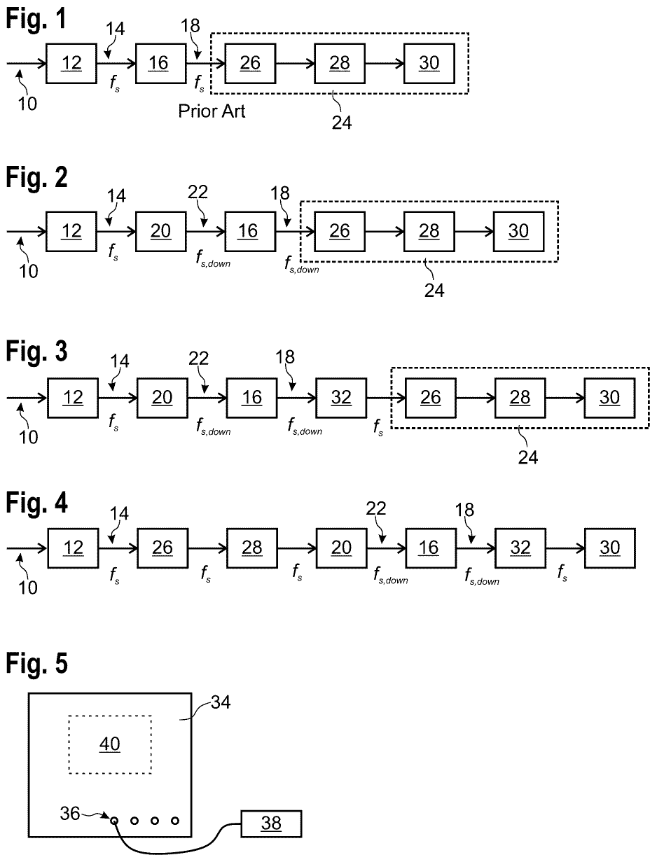

Accordingly, signals can be equalized, for example via the method schematically illustrated in FIG. 1. An input signal 10 is received and sampled by an analog-to-digital converter 12 at a pre-defined sampling rate fₛ. Thereby, a sampled signal 14 is obtained. Subsequently, a digital filter 16 is applied to the sampled signal 14, which results in a filtered signal 18 having an at least partially corrected frequency response. The knowledge of the actual frequency response is used for correcting the frequency response via the digital filter 16.

The digital filter 16 is followed by a processing module 24 that comprises an acquisition circuit 26, an acquisition memory 28, and a processing circuit 30. The filtered signal 18 is processed by the acquisition circuit 26 and written into the acquisition memory 28. Subsequently, the filtered signal 18 is processed further (e.g. analyzed) by the processing circuit 30.

The digital filter 16 is implemented via digital signal processing and thus in a sampled (discrete-time) system. For the digital filter 16, a finite impulse response (FIR) filter is typically used. However, the use of an FIR filter brings along some limitations. More specifically, the process of sampling the signal has to fulfill the sampling theorem. Accordingly, the relation fₛ>2·f_{c} has to hold, where fₛ is the sampling frequency and f_{c} is the cutoff frequency of the system.

The relation fₛ>2·f_{c} applies to baseband signals. The corresponding relation for passband signals is obtained by replacing the cutoff frequency f_{c} with the occupied bandwidth B of the signal.

For a given sampling frequency fₛ and available filter length, very small or very large cutoff frequencies are not possible. Cutoff frequency limits that allow calculating the filter with a reasonable amount of effort are: maximum cutoff frequency f_{c,max}≈0.45·fₛ fs and minimum cutoff f_{g,min}≈0.01·fₛ. As a specific example, given a sampling frequency fₛ of 5 GHz, the frequency range that would be correctable via the digital filter 16 spans 50 MHz to 2 GHz.

While these limits can be moved in theory, this would require increasing the impulse response, which would result in a substantial increase of computational complexity. Thus, computing hardware with very high processing speed would be necessary, which makes this approach inefficient and costly.

Accordingly, if an undesired frequency response is to be corrected in the low-frequency range, this cannot be solved by increasing the filter length without unreasonable effort. However, some measuring devices, e.g. current clamps, are associated with low cutoff frequencies. The method illustrated in FIG. 1 is of limited use for such low-frequency devices.

FIG. 2 schematically illustrates a method for equalizing an input signal 10, which addresses issues with low frequency signals of the method described above.

An input signal 10 is received and sampled by an analog-to-digital converter 12 at a pre-defined sampling rate fₛ. Thereby, a sampled signal 14 is obtained.

Subsequently, a decimating filter 20 is applied to the sampled signal 14, which results in a decimated signal 22 having a reduced sampling rate. The sampling rate fₛ is reduced by a fixed decimation factor d. This results in a reduced sampling rate f_{s,down}=fₐ/d. The decimation factor d is especially an integer.

The reduction of the sampling rate is to comply with the sampling theorem. Accordingly, the decimation is to be performed via a band limiting filter. In this example, the decimation is realized via a cascaded integrator-comb (CIC) filter. A CIC filter is a specific realization of a filter that is decimating as well as band limiting. Of course, other filter types with this property can be used as well.

Thereafter, a digital filter 16 is applied to the sampled signal 14, which results in a filtered signal 18 having an at least partially corrected frequency response. The knowledge of the actual frequency response is used for correcting the frequency response via the digital filter 16.

The decimation of the sampling rate upstream of the digital filter 16 solves the problem with low-frequency signals described above. The frequency response correction now relates to the reduced sampling frequency f_{s,down}. Assuming that the upper cutoff frequency of the frequency response is small as well, frequency responses can be corrected in frequency ranges that are virtually arbitrarily low, without increasing the filter length.

The digital filter 16 is followed by a processing module 24, which comprises an acquisition circuit 26, an acquisition memory 28, and a processing circuit 30. The filtered signal 18 is processed by the acquisition circuit 26 and written into the acquisition memory 28. Subsequently, the filtered signal 18 is processed further (e.g. analyzed) by the processing circuit 30.

In most applications, downstream signal processing (e.g. via an oscilloscope) can work properly with the signal having the reduced sampling frequency. However, some applications may rely on the signal having the original sampling frequency.

To address this, the sampling frequency can be increased again by the decimation factor d via interpolation. A corresponding modification to the method of FIG. 1 is illustrated in FIG. 3. For conciseness, only the difference with respect to FIG. 2 is described hereinafter.

An interpolator 32 is applied to the filtered signal 18 for up-sampling so as to return to essentially the pre-defined sampling rate. In the depicted example, the interpolator 32 provided downstream of the digital filter 16 is an interpolating CIC filter, which increases the sampling frequency by the factor d back to the original value fₛ.

FIG. 4 relates to a modification of the method illustrated in FIG. 3. As can be seen, the sampled signal 14 is first processed via the acquisition circuit 26 and written into the acquisition memory 28 before the decimating filter 20 is applied to it.

Subsequently, the digital filter 16 is applied to the decimated signal 22 for correcting the frequency response.

Thereafter, the interpolator 32 is applied to the filtered signal 18 for up-sampling so as to return to essentially the pre-defined sampling rate.

Finally, the filtered signal 18 is processed further (e.g. analyzed) in the processing circuit 30. If not required for the further processing, the step of up-sampling via the interpolator 32 may also be omitted.

FIG. 5 schematically illustrates an equalization apparatus 34 for equalizing an input signal 10. In the shown example, the equalization apparatus 34 is an oscilloscope.

The equalization apparatus 34 comprises an input 36 for receiving an input signal 10. A measuring device 38, e.g. a probe or a clamp, is connected to the equalization apparatus 34. Accordingly, the input signal 10 originates from the measuring device 38.

The equalization apparatus 34 comprises an electronic circuit 40 configured to perform a method as described herein. Especially, the method comprises the following steps:
sampling the input signal 10 with a pre-defined sampling rate, thereby obtaining a sampled signal 14;
applying a decimating filter 20 to the sampled signal 14, which results in a decimated signal 22 having a reduced sampling rate; and
applying a digital filter 16 to the decimated signal 22, thereby obtaining a filtered signal 18 having an at least partially corrected frequency response.

An undesired frequency response of the measuring device 38 can thus be corrected.

In the example shown in FIG. 5, the equalization apparatus 34 comprises in total four inputs 36. The electronic circuit 40 may be configured to perform the method on at least two channels of the equalization apparatus 34.

Certain embodiments disclosed herein utilize circuitry (e.g., one or more circuits) in order to implement protocols, methodologies or technologies disclosed herein, operably couple two or more components, generate information, process information, analyze information, generate signals, encode/decode signals, convert signals, transmit and/or receive signals, control other devices, etc. Circuitry of any type can be used.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method for equalizing an input signal, wherein the method comprises the following steps:
receiving an input signal;
sampling the input signal with a pre-defined sampling rate, thereby obtaining a sampled signal;
applying a decimating filter to the sampled signal, which results in a decimated signal having a reduced sampling rate; and
applying a digital filter to the decimated signal, thereby obtaining a filtered signal having an at least partially corrected frequency response.

2. The method according to claim 1, wherein the decimating filter is a cascaded integrator-comb filter.

3. The method according to claim 1, wherein the decimating filter comprises a cascade of at least two low-pass filters.

4. The method according to claim 3, wherein the cascade comprises at least one finite impulse response filter and a cascaded integrator-comb filter.

5. The method according to claim 1, wherein the decimating filter is an alias free filter.

6. The method according to claim 1, wherein an interpolator is applied to the filtered signal for up-sampling so as to return to essentially the pre-defined sampling rate.

7. The method according to claim 6, wherein the interpolator is a finite impulse response filter.

8. The method according to claim 6, wherein the interpolator is a cascaded integrator-comb filter.

9. The method according to claim 6, wherein an up-sampled signal is obtained, which is acquired and processed further.

10. The method according to claim 1, wherein the digital filter used for correcting the frequency response corrects a magnitude and a phase of the input signal at least partially.

11. The method according to claim 1, wherein the input signal is a measurement signal from a measuring device.

12. The method according to claim 11, wherein the measuring device is a probe or a clamp.

13. An equalization apparatus for equalizing an input signal, the equalization apparatus comprising an input for receiving an input signal and an electronic circuit configured to perform a method comprising the following steps:
sampling the input signal with a pre-defined sampling rate, thereby obtaining a sampled signal;
applying a decimating filter to the sampled signal, which results in a decimated signal having a reduced sampling rate; and
applying a digital filter to the decimated signal, thereby obtaining a filtered signal having an at least partially corrected frequency response.

14. The equalization apparatus according to claim 13, wherein the equalization apparatus comprises at least two inputs and wherein the electronic circuit is configured to perform the method on at least two channels.

15. The equalization apparatus according to claim 13, wherein the electronic circuit is configured to apply the decimating filter to the sampled signal after writing the sampled signal to an acquisition memory of the equalization apparatus and before performing further signal processing.

16. The equalization apparatus according to claim 15, wherein the electronic circuit is configured to apply the digital filter to the decimated signal for correcting the frequency response before performing further signal processing.

17. The equalization apparatus according to claim 16, wherein the electronic circuit is configured to apply an interpolator to the filtered signal for up-sampling so as to return to essentially the pre-defined sampling rate after correcting the frequency response and before performing further signal processing.

18. The equalization apparatus according to claim 13, wherein the equalization apparatus is an oscilloscope.
